(19) United States
(12) Patent Application Publication
(10) Pub. No.: US 2024/0221056 A1
(43) Pub. Date: Jul. 4, 2024

(54) METHOD AND APPARATUS FOR PRESENTING SEARCH SCREENING ITEMS, ELECTRONIC DEVICE, AND STORAGE MEDIUM

(71) Applicant: Beijing Zitiao Network Technology Co., Ltd., Beijing (CN)

(72) Inventor: Liping ZHU, Beijing (CN)

(21) Appl. No.: 18/521,724

(22) Filed: Nov. 28, 2023

(30) Foreign Application Priority Data
Jan. 3, 2023 (CN) 202310002739.5

(51) Int. Cl. G06Q 30/0601

(52) U.S. Cl. CPC G06Q 30/0631

(57) ABSTRACT

The present disclosure provides a method and apparatus for presenting search screening items, an electronic device, and a storage medium; and the method includes: in response to receiving search information, acquiring a plurality of recommended search terms matched with the search information; determining a sequence of screening items obtained after mixing and sorting the plurality of recommended search terms and vertical category tags; and presenting the sequence of screening items obtained after the mixing and sorting in a navigation bar of a search page.

### CROSS-REFERENCE TO RELATED APPLICATIONS

The present disclosure is based on and claims priority to China Patent Application No. 202310002739.5 filed on Jan. 3, 2023 and entitled as “method and apparatus for presenting search screening items, electronic device, and storage medium”, the disclosure of which is incorporated by reference herein in its entirety.

### TECHNICAL FIELD

The present disclosure relates to the technical field of computer technology, and in particular, to a method and apparatus for presenting search screening items, an electronic device, and a storage medium.

### BACKGROUND

Generally, a plurality of vertical category tags can be presented in a navigation bar of a search page, and a user can screen search results based on the vertical category tags. In some cases, in order to better guide the user to conduct a search, some search terms are also recommended to the user, so as to guide the user to locate the information as needed by himself/herself through a search in a more accurate and swift manner.

### SUMMARY

The present disclosure at least provides a method and apparatus for presenting search screening items, an electronic device, and a storage medium.

In a first aspect, the present disclosure provides a method for presenting search screening items, comprising:
in response to receiving search information, acquiring a plurality of recommended search terms matched with the search information;
determining a sequence of screening items obtained after mixing and sorting the plurality of recommended search terms and vertical category tags; and
presenting the sequence of screening items obtained after the mixing and sorting in a navigation bar of a search page.

In a possible implementation, the determining a sequence of screening items obtained after mixing and sorting the plurality of recommended search terms and vertical category tags comprises:
determining an association relation between each of the recommended search terms and each of the vertical category tags, based on consumption data of multimedia content corresponding to each of the recommended search terms under each of the vertical category tags; and
determining the sequence of screening items obtained after mixing and sorting the plurality of recommended search terms and vertical category tags in accordance with the determined association relation.

In a possible implementation, the sequence of screening items is generated in accordance with the following steps of:
determining a priority order of the vertical category tags based on the search information;
determining a plurality of prepositive vertical category tags from the vertical category tags in accordance with the priority order; and
taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

In a possible implementation, the determining a priority order of the vertical category tags based on the search information comprises:
determining the priority order of the vertical category tags based on consumption data of multimedia content under a search category to which the search information belongs.

In a possible implementation, the determining a plurality of prepositive vertical category tags from the vertical category tags in accordance with the priority order comprises:
selecting a first number of first vertical category tags which are top-ranked, in an order from high to low of the priority order; and
performing a union process on the first number of first vertical category tags and a plurality of preset second vertical category tags, and taking the vertical category tags in the resulted union as the plurality of prepositive vertical category tags.

In a possible implementation, the taking what is resulted after mixing and sorting the plurality of prepositive vertical category tags and the plurality of recommended search terms as prepositive screening items of the sequence of screening items comprises:
in the case where the number of the recommended search terms is greater than a second number, selecting the second number of recommended search terms from the plurality of recommended search terms, in accordance with degree of correlation between the plurality of recommended search terms and the search information and/or consumption data of multimedia content corresponding to the plurality of recommended search terms; and
taking what is resulted after mixing and sorting the plurality of prepositive vertical category tags and the second number of recommended search terms as the prepositive screening items of the sequence of screening items; and
the taking vertical category tags other than the prepositive vertical category tags among the vertical category tags as postpositive screening items of the sequence of screening items comprises:
taking the vertical category tags other than the prepositive vertical category tags, as well as the recommended search terms other than the second number of recommended search terms among the plurality of recommended search terms, as the postpositive screening items of the sequence of screening items.

In a possible implementation, prior to mixing and sorting the plurality of recommended search terms and vertical category tags, the method further comprises:
performing a semantic match on the plurality of recommended search terms and the vertical category tags, and determining whether there is a recommended search term which is semantically matched with the vertical category tag among the plurality of recommended search terms; and
if yes, deleting the recommended search term which is semantically matched with the vertical category tag.

In a possible implementation, subsequent to presenting the sequence of screening items obtained after the mixing and sorting, the method further comprises:
adjusting the order of respective screening items in the sequence of screening items in accordance with trigger operation data for the respective screening items in the sequence of screening items.

In a possible implementation, subsequent to presenting the sequence of screening items obtained after the mixing and sorting, the method further comprises:
in response to a trigger operation for a target vertical category tag in the sequence of screening items, setting the target vertical category tag to be in a selected state, and presenting respective search results under the target vertical category tag for the search information; and/or
in response to a trigger operation for a recommended search term in the sequence of screening items, setting a comprehensive tag in the search page to be in a selected state, and presenting respective search results matched with the search information and the recommended search term.

Reference is made to the description of the above method for the description of effects of the apparatus and electronic device as mentioned below, and no repetition is further made here.

In a second aspect, the present disclosure provides an apparatus for presenting search screening items, comprising:
an acquiring module configured to, in response to receiving search information, acquire a plurality of recommended search terms matched with the search information;
a determining module configured to determine a sequence of screening items obtained after mixing and sorting the plurality of recommended search terms and vertical category tags; and
a first presenting module configured to present the sequence of screening items obtained after the mixing and sorting in a navigation bar of a search page.

In a third aspect, the present disclosure provides an electronic device, which comprises a processor, a memory, and a bus, wherein the memory stores machine-readable instructions executable by the processor, the processor and the memory communicate via the bus when the electronic device runs, and the machine-readable instructions, when executed by the processor, cause the processor to perform the method for presenting search screening items in accordance with the above first aspect or any one of the above implementations.

In a fourth aspect, the present disclosure provides a non-transitory computer-readable storage medium, storing thereon a computer program which, when executed by a processor, causes the processor to perform the method for presenting search screening items in accordance with the above first aspect or any one of the above implementations.

In order to make the above-mentioned objectives, features, and advantages of the present disclosure more apparent and easy to understand, hereinafter, preferred embodiments are described in detail with reference to the accompanying drawings as follows.

### BRIEF DESCRIPTION OF THE DRAWINGS

In order to illustrate the technical solutions of the embodiments of the present disclosure in a more clearly manner, the accompanying drawings necessary to be used in the embodiments will be briefly described below; the accompanying drawings herein are incorporated in and form a part of the description; they illustrate embodiments consistent with the present disclosure and, together with the description, serve to illustrate the technical solutions of the present disclosure. It is to be understood that the following drawings only depict some embodiments of the present disclosure and are therefore not to be construed as limiting the scope, and for those skilled in the art, other relevant drawings may be derived from these drawings without any creative effort.

FIG. 1a is a schematic diagram illustrating an interface which presents vertical category tags in a search page provided by an embodiment of the present disclosure;

FIG. 1b is a schematic diagram illustrating an interface which presents vertical category tags and recommended search terms in different areas in a search page provided by an embodiment of the present disclosure;

FIG. 2 is a flowchart of a method for presenting search screening items provided by an embodiment of the present disclosure;

FIG. 3 is a schematic diagram illustrating an interface which presents screening items obtained after mixing and sorting in a method for presenting search screening items provided by an embodiment of the present disclosure;

FIG. 4 is a schematic structural diagram of an apparatus for presenting search screening items provided by an embodiment of the present disclosure; and

FIG. 5 is a schematic structural diagram of an electronic device provided by an embodiment of the present disclosure.

### DETAILED DESCRIPTION

To make the objectives, technical solutions, and advantages of the embodiments of the present disclosure more clearly comprehensible, the technical solutions in the embodiments of the present disclosure will be described clearly and completely with reference to the accompanying drawings in the embodiments of the present disclosure, and it is clear that the embodiments as described are only a part of the embodiments of the present disclosure, rather than all of the embodiments. The components of the embodiments of the present disclosure, as described and illustrated in the accompanying drawings herein, can generally be arranged and designed in a variety of different configurations. Thus, the following detailed description of the embodiments of the present disclosure, as provided in the accompanying drawings, is not intended to limit the scope of protection of the present disclosure, but is merely representative of selected embodiments of the present disclosure. All other embodiments, which can be derived by those skilled in the art based on the embodiments of the present disclosure without making any creative effort, shall fall within the scope of protection of the present disclosure.

When the recommended search terms are presented, they are generally presented in a presentation area outside the navigation bar, and the problem of large consumption of page presentation resources exists in such a presentation manner on one hand, and on the other hand, such a presentation manner also makes it inconvenient for the user to view and use.

The above method and apparatus for presenting search screening items, an electronic device, and a storage medium as provided by embodiments of the present disclosure may, in response to receiving search information, acquiring a plurality of recommended search terms matched with the search information, and further may determine a sequence of screening items obtained after mixing and sorting the plurality of recommended search terms and vertical category tags; and then may present the sequence of screening items obtained after the mixing and sorting in a navigation bar of a search page. In the navigation bar of the search page, the sequence of screening items obtained after mixing and sorting the plurality of recommended search terms and the vertical category tags is presented. Hence the embodiments of the present disclosure may present the recommended search terms and the vertical category tags in the navigation bar in a mixed manner, which saves the page presentation resources on one hand, and on the other hand, also makes it easier for a user to view and use the screening items.

Generally, when a user conducts a search for information, a plurality of vertical category tags can be presented in the navigation bar of the search page so as to screen the search results. Sometimes, in order to better guide the user to conduct a search, some search terms are also recommended to the user, so as to guide the user to locate the information as needed by himself/herself through a search in a more accurate and swift manner.

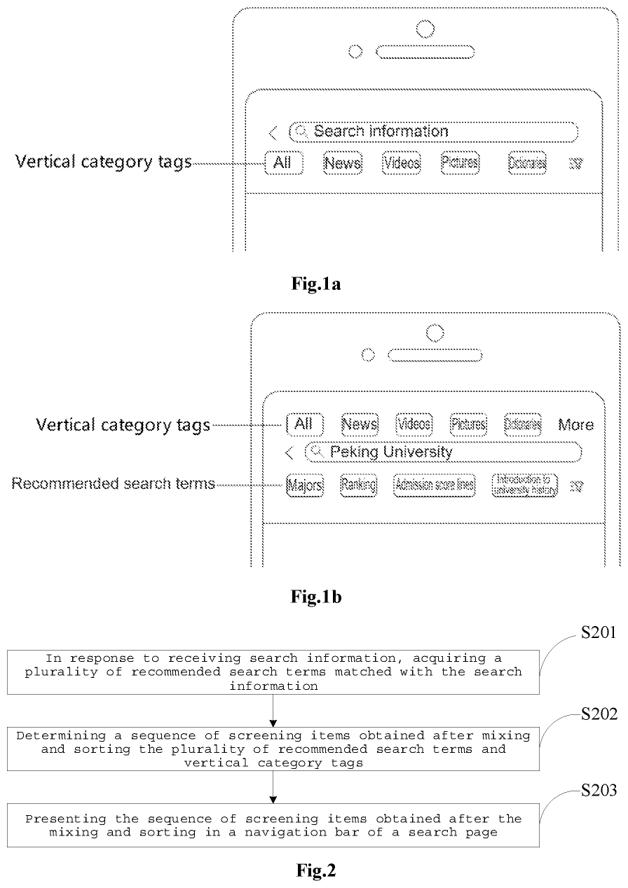

Usually, as shown in FIG. 1a, under one circumstance, only a plurality of vertical category tags are presented in the search page, and the presentation area where the plurality of vertical category tags are located may be referred to as a navigation bar area. As shown in FIG. 1b, the vertical category tags and the recommended search terms are synchronously presented in the search page, however, the vertical category tags and the recommended search terms are presented in different areas, as in the figure, the vertical category tags and the recommended search terms are respectively presented at the upper position and the lower position of the area where the search box is located; as can be seen, when the recommended search terms are presented, they are presented in an additional presentation area, and the problem of large consumption of page presentation resources exists in such a presentation manner on one hand, and on the other hand, such a presentation manner makes it inconvenient for the user to view and use the vertical category tags and the recommended search terms in a unified manner.

On this basis, the embodiments of the present disclosure provide a method and apparatus for presenting search screening items, an electronic device, and a storage medium.

It should be noted that similar reference signs and letters refer to similar items in the subsequent drawings, and thus, once an item is defined in one drawing, it is not necessary to further define and explain it in the subsequent drawings.

The term “and/or” herein merely describes an association relationship, and means that three relationships may exist; for example, A and/or B may mean three cases, namely A exists alone, A and B exist simultaneously, and B exists alone. Further, the term “at least one” herein means any one of multiple or any combination of at least two of multiple; for example, including at least one of A, B and C may mean including any one or more elements selected from the group consisting of A, B and C.

To facilitate understanding of the embodiments of the present disclosure, a method for presenting search screening items as disclosed in an embodiment of the present disclosure will be first described in detail. The main body of execution of the method for presenting search screening items provided by an embodiment of the present disclosure is generally a computer device with certain computing power, and the computer device comprises, for example, a terminal device or a server or other processing devices, wherein the terminal device may be a User Equipment (UE), a mobile device, a user terminal, a terminal, a cellular phone, a cordless phone, a Personal Digital Assistant (PDA), a hand-held device, a computing device, a vehicle-mounted device, etc. In some possible implementations, the method for presenting search screen items may be implemented by a processor calling computer-readable instructions stored in a memory.

The method for presenting search screening items provided by an embodiment of the present disclosure is described below by taking a user end being a terminal device as an example.

### Embodiment One

Referring to FIG. 2, which is a flowchart of a method for presenting search screening items provided by an embodiment of the present disclosure, the method comprises steps S201 to S203, specifically as follows:
S201, in response to receiving search information, acquiring a plurality of recommended search terms matched with the search information.
S202, determining a sequence of screening items obtained after mixing and sorting the plurality of recommended search terms and vertical category tags.
S203, presenting the sequence of screening items obtained after the mixing and sorting in a navigation bar of a search page.

Upon receiving search information, a plurality of recommended search terms matched with the search information may be acquired, wherein the plurality of recommended search terms may be determined in accordance with historical search data associated with the search information. For example, respective initial search terms associated with the search information may be extracted from the global historical search data, and then final recommended search terms may be obtained by sorting and screening the respective initial search terms in accordance with consumption data of multimedia content corresponding to the respective initial search terms as extracted.

The vertical category tags may be vertical category tags originally in the search page (including the vertical category tags that are displayed and those that are not displayed but can be displayed through a sliding switchover on the search page), or may be vertical category tags within a certain number screened from the original vertical category tags.

After mixing and sorting the recommended search terms and the vertical category tags, a sequence of screening items containing the recommended search terms and the vertical category tags which are mixed and sorted is obtained, and the sequence of screening items, namely the sorted recommended search terms and vertical category tags, is synchronously presented in an area of the same position of a search page, namely in the navigation bar where the vertical category tags are originally located.

By adopting the above method, the recommended search terms and the vertical category tags can be presented in the area of the same position in a mixed manner, which saves the page presentation resources on one hand, and on the other hand, also makes it easier for a user to view and use the screening items in a unified manner.

The above steps S201 to S203 are described below in a relatively more detailed manner.

In the above S201, the search information is a search term or a search sentence input by the user in a search bar. Taking the search information being electric bicycle or principal of Peking University as an example, after the user inputs the search information, a plurality of recommended search terms matched with the search information may be refined and acquired based on the historical search records; for example, when the search information is “electric bicycle”, the recommended search terms may include accessories, brands, evaluations, and the like; when the search information is “Peking University”, the recommended search terms may comprise campus videos, ranking, principal, introduction to university history, admission score lines, and the like; when the search information is “who is the principal of Peking University”, the recommended search terms may include principal, profile of principal, and the like.

In the above S202, the vertical category tags may include tags corresponding to different content genres, such as videos, short videos, news, pictures, and the like, and may further include various tags related to types or attributes of multimedia content, such as entertainment, science and technology, health, hotspot, etc. After a plurality of recommended search terms are acquired, the plurality of recommended search terms and the vertical category tags may be screened and mixed-and-sorted to determine a sequence of screening items obtained after mixing and sorting the plurality of recommended search terms and the vertical category tags. In a specific implementation, if there is a case where no recommended search term matched with the search information exists, it is only necessary to determine a sequence of screening items obtained after sorting the vertical category tags at this time.

In a possible implementation, when the plurality of recommended search terms and the vertical category tags are mixed and sorted, the recommended search term and the vertical category tag having an association relation in terms of consumption can be adjacently presented, so as to meet the demand of the user on nearby consumption. In this way, after triggering a certain recommended search term for search, the user can select nearby the vertical category tag which can best meet the consumption demand, and further screen the search results. The following steps may be specifically performed:
Step A1, determining an association relation between each of the recommended search terms and each of the vertical category tags, based on consumption data of multimedia content corresponding to each of the recommended search terms under each of the vertical category tags.
Step A2, determining the sequence of screening items obtained after mixing and sorting the plurality of recommended search terms and vertical category tags in accordance with the determined association relation.

In an implementation, it is possible to, based on the consumption data of the multimedia content corresponding to each of the recommended search terms under each of the vertical category tags, determine the association relation between each of the recommended search terms and each of the vertical category tags; that is, for each of the recommended search terms, in accordance with the consumption data, such as hit count, playing count, and sharing rate, and the like of the multimedia content corresponding to the recommended search term under each of the vertical category tags, degree of association between each of the recommended search terms and each of the vertical category tags is determined; wherein each of the recommended search terms may be associated with one or more vertical category tags, and each of the vertical category tags may also be associated with one or more recommended search terms.

Exemplarily, if the vertical category tags include news, videos, and pictures, when the search information is “Peking University”, with respect to recommended search term “principal”, in accordance with the reading count (2000 times) under the vertical category tag “news”, the playing count (500 times) under the vertical category tag “videos”, and the watching count (1500 times) under the vertical category tag “pictures” of the multimedia content corresponding to the recommended search term “principal”, it can be determined that the degree of association between the recommended search term “principal” and the vertical category tag “news” is 0.5, namely, 2000/(2000+500+1500)=0.5; the degree of association between the recommended search term “principal” and the vertical category tag “videos” is 0.125, namely, 500/(2000+500+1500)=0.125; the degree of association between the recommended search term “principal” and the vertical category tag “pictures” is 0.375, namely, 1500/(2000+500+1500)=0.375; in a practical implementation, respective pieces of data may be subjected to a normalization process and then to a weighted summation; herein, it is only briefly illustrated.

Furthermore, the sequence of screening items obtained after mixing and sorting the plurality of recommended search terms and the vertical category tags can be determined in accordance with the determined association relations, and further to the above example, it can be determined that the sequence of screening items obtained after the mixing and sorting is principal, news, pictures, and videos, namely the recommended search term “principal” can be associated with the vertical category tag “news”; alternatively, it can be determined that the sequence of screening items obtained after the mixing and sorting is news, principal, pictures, and videos, namely the recommended search term “principal” can be associated with the vertical category tag “news” and the vertical category tag “pictures”.

Alternatively, when the search information is “Peking University”, the degree of association between the recommended search term “ranking” and the vertical category tag “pictures” is higher than the degree of association between the recommended search term “ranking” and the vertical category tag “news”, and the degree of association between the recommended search term “ranking” and the vertical category tag “news” is higher than the degree of association between the recommended search term “ranking” and the vertical category tag “videos”. At this time, it may be determined that the sequence of screening items obtained after the mixing and sorting is news, principal, pictures, ranking, and videos, that is, the vertical category tag “news” may be associated with the recommended search term “principal”, and the vertical category tag “pictures” may be associated with the recommended search term “principal” and the recommended search term “ranking”.

Here, based on the association relations between the recommended search terms and the vertical category tags, the plurality of recommended search terms and the vertical category tags are sorted and presented, and the recommended search term and the vertical category tag having an association relation in terms of consumption can be adjacently presented, so as to the demand of the user on nearby consumption can be met; for example, as to a certain recommended search term, there is a relatively large amount of consumption data of multimedia content under a certain vertical tag, and when this recommended search term and this vertical category tag are adjacently presented, after triggering this recommended search term for search, a user confirms that he or she is most interested in the search results under this vertical category tag in the search page, and at this time this vertical category tag can be triggered quickly to obtain more accurate search results.

In a possible implementation, in the case where there are a relatively large number of vertical category tags, in order to ensure that the strongly demanded vertical category tags and the recommended search terms can be presented in the current page, the important tags among the vertical category tags and the recommended search terms can be mixed-and-sorted and displayed in a prepositive manner. It specifically comprises:
Step B1, determining a priority order of the vertical category tags based on the search information;
Step B2, determining a plurality of prepositive vertical category tags from the vertical category tags in accordance with the priority order; and
Step B3, taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

Among the above steps, determining a priority order of the vertical category tags based on the search information, and determining a plurality of prepositive vertical category tags from the vertical category tags in accordance with the priority order; that is, the determined prepositive vertical category tags are usually strongly demanded vertical category tags that are more matched with the search demand, and the search screening demand of a user can be better satisfied by guaranteeing the prioritized presentation of these prepositive vertical category tags.

In an implementation, the priority order of the vertical category tags can be first determined based on the search information, and the plurality of prepositive vertical category tags can be determined from the vertical category tags in accordance with the priority order, namely the plurality of prepositive vertical category tags are determined from the vertical category tags in accordance with an order from high to low of the priority; wherein the number of the prepositive vertical category tags can be determined depending on actual needs, which may be 3 or 4 or the like, for example. Furthermore, what is resulted after mixing and sorting the plurality of prepositive vertical category tags and the plurality of recommended search terms can be taken as the prepositive screening items of the sequence of screening items, and vertical category tags other than the prepositive vertical category tags among the vertical category tags can be taken as the postpositive screening items of the sequence of screening items; wherein the prepositive screening items are arranged before the postpositive screening items.

In a specific implementation, the priority order of the vertical category tags can be determined in accordance with consumption data of multimedia content, that is, the priority order of the vertical category tags can be determined based on consumption data of multimedia content under a search category to which the search information belongs.

In an implementation, the priority order of the vertical category tags can be determined based on consumption data of multimedia content under a search category to which the search information belongs; the search category to which the search information belongs may refer to a field category, for example, if the search information is mobile phone of a certain brand, then the search category may be a category of mobile phone or a category of electric appliance; and based on the consumption data of the multimedia content of each of the vertical category tags under this search category, it can be concluded that the consumption data corresponding to the vertical category tag of e-commerce earns the highest score, which is followed by that of live streams and videos, that is, the priority of the vertical category tag of e-commerce is ranked first, and live streams and videos are ranked second.

Here, the priority order of the vertical category tags is determined based on the consumption data of the multimedia content under a search category to which the search information belongs, which, at the same time of meeting the user's demands, can make sure that the strongly demanded vertical category tags may be determined subsequently from the vertical category tags in accordance with the priority order.

In a specific implementation, Step B2, determining a plurality of prepositive vertical category tags from the vertical category tags in accordance with the priority order comprises: selecting a first number of first vertical category tags which are top-ranked, in an order from high to low of the priority order; and performing a union process on the first number of first vertical category tags and a plurality of preset second vertical category tags, and taking the vertical category tags in the resulted union as the plurality of prepositive vertical category tags.

Here, the selected first vertical category tags with higher priorities are namely the vertical category tags which are more matched with the search demand of the search information, while the preset second vertical category tags are usually the vertical category tags which are empirically corresponding to the user's strong intention of vertical search, such as vertical category tags of videos, short videos, and the like; and in order to cover the strongly demanded vertical category tags of the user in a relatively comprehensive manner, the first vertical category tags and the second vertical category tags are subjected to a union process, namely resulting in the vertical category tags which contain the first vertical category tags and the second vertical category tags and have no semantic repetition to serves as the plurality of prepositive vertical category tags.

Here, the first number and the plurality of preset second vertical category tags may be determined in accordance with actual conditions; for example, the first number may be 3, 4, etc.; the plurality of preset second vertical category tags may include some tags that empirically correspond to strong intention of vertical search, such as videos, short videos, users, and so on.

Exemplarily, taking the first number being 3 as an example, in the case where a plurality of preset second vertical category tags include videos, short videos, and users, and the priority order from high to low of the vertical category tags is determined to be pictures, videos, short videos, encyclopedias, users, news, music, and Q&As, the first vertical category tags include pictures, videos, and short videos, and a union process is performed on the first number of first vertical category tags (pictures, videos, and short videos) and the plurality of preset second vertical category tags (videos, short videos, and users), the vertical category tags in the resulted union include pictures, videos, short videos, and users, that is, the plurality of prepositive vertical category tags include pictures, videos, short videos, and users.

In a specific implementation, in the case where there are a relatively large number of recommended search terms, the recommended search terms may be screened in combination with degree of correlation between the recommended search terms and the search information and consumption data of multimedia content corresponding to the recommended search terms, so as to guarantee prioritized presentation of the recommended search terms which are highly matched with the actual demands.

Specifically, the taking what is resulted after mixing and sorting the plurality of prepositive vertical category tags and the plurality of recommended search terms as prepositive screening items of the sequence of screening items comprises:
Step B31, in the case where the number of the recommended search terms is greater than a second number, selecting the second number of recommended search terms from the plurality of recommended search terms, in accordance with degree of correlation between the plurality of recommended search terms and the search information and/or consumption data of multimedia content corresponding to the plurality of recommended search terms.
Step B32, taking what is resulted after mixing and sorting the plurality of prepositive vertical category tags and the second number of recommended search terms as the prepositive screening items of the sequence of screening items;

In Step B3, the taking vertical category tags other than the prepositive vertical category tags among the vertical category tags as postpositive screening items of the sequence of screening items comprises:
Step B33, taking the vertical category tags other than the prepositive vertical category tags, as well as the recommended search terms other than the second number of recommended search terms among the plurality of recommended search terms, as the postpositive screening items of the sequence of screening items.

In an implementation, in the case where the number of the recommended search terms is greater than a second number, the second number of recommended search terms can be selected from the plurality of recommended search terms, in accordance with the degree of correlation between the plurality of recommended search terms and the search information; alternatively, the second number of recommended search terms can be selected from the plurality of recommended search terms, in accordance with the consumption data of the multimedia content corresponding to the plurality of recommended search terms; further alternatively, the second number of recommended search terms can be selected from the plurality of recommended search terms, in accordance with the degree of correlation between the plurality of recommended search terms and the search information and the consumption data of the multimedia content corresponding to the plurality of recommended search terms.

Specifically, with respect to the degree of correlation between the recommended search terms and the search information, Euclidean distances between a semantic feature vector corresponding to each of the recommended search terms and a semantic feature vector of the search information can be calculated, and the smaller the Euclidean distance is, the higher the degree of correlation between the recommended search term and the search information is; alternatively, the degree of correlation between each of the recommended search terms and the search information can also be determined by utilizing a neural network with a function of calculating a text similarity. With respect to the consumption data of the multimedia content corresponding to the plurality of recommended search terms, the consumption data of the multimedia content corresponding to each of the recommended search terms may be counted, and the consumption data may include hit count, reading count, playing count, sharing rate, like count, etc. Furthermore, the second number of recommended search terms may be selected from the plurality of recommended search terms in accordance with the order from high to low of the degree of correlation between the plurality of recommended search terms and the search information and/or the order from high to low of the consumption data of the multimedia content corresponding to the plurality of recommended search terms. Here, the second number may be determined depending on actual needs, which may be 10 or 15 or the like, for example.

Then, what is resulted after mixing and sorting the plurality of prepositive vertical category tags and the second number of recommended search terms can be taken as the prepositive screening items of the sequence of screening items; reference can be made to Step A1 and Step A2 for the execution process thereof, and no repetition is further made herein. Furthermore, when vertical category tags other than the prepositive vertical category tags among the vertical category tags are taken as postpositive screening items of the sequence of screening items, the vertical category tags other than the prepositive vertical category tags, as well as the recommended search terms other than the second number of recommended search terms among the plurality of recommended search terms, can be taken as the postpositive screening items of the sequence of screening items.

Exemplarily, if the plurality of recommended search terms include a recommended search term 1, a recommended search term 2, . . . , a recommended search term 19, and a recommended search term 20, and the second number is 5; in the case where the priority order from high to low of the vertical category tags is pictures, videos, short videos, encyclopedias, users, news, music, and Q&As, and the resulted prepositive screening items after mixing and sorting the plurality of prepositive vertical category tags (pictures, videos, short videos and users) and a second number of recommended search terms (recommended search term 1 to recommended search term 5) include pictures, the recommended search term 1, videos, short videos, the recommended search term 2, the recommended search term 3, users, the recommended search term 4, and the recommended search term 5, the vertical category tags other than the prepositive vertical category tags include encyclopedias, news, music, and Q&As, and the recommended search terms other than the second number of recommended search terms include the recommended search term 6 to the recommended search term 20; thus, it may be determined that the postpositive screening terms include encyclopedias, news, music, Q&As, the recommended search term 6, the recommended search term 7, . . . , the recommended search term 19, and the recommended search term 20, alternatively, it may be determined that the postpositive screening terms include the recommended search term 6, the recommended search term 7, . . . , the recommended search term 19, the recommended search term 20, encyclopedias, news, music, and Q&As.

In an implementation, in the case where the number of the recommended search terms is smaller than or equals to the second number, it is not necessary to select the second number of recommended search terms from the plurality of recommended search terms, rather, what is resulted after mixing and sorting the plurality of prepositive vertical category tags and the plurality of recommended search terms can be directly taken as the prepositive screening items of the sequence of screening items; and vertical category tags other than the prepositive vertical category tags can be taken as the postpositive screening items of the sequence of screening items.

Here, in the case where the number of the recommended search terms is greater than the second number, the second number of recommended search terms are selected from the plurality of recommended search terms in combination with the degree of correlation between the plurality of recommended search terms and the search information and/or the consumption data of the multimedia content corresponding to the plurality of recommended search terms, which can guarantee that the selected second number of recommended search terms are highly matched with the actual demands, and furthermore, what is resulted after mixing and sorting the plurality of prepositive vertical category tags and the second number of recommended search terms are taken as the prepositive screening items of the sequence of screening items; that is, the recommended search terms and the vertical category tags with relatively high degree of demand are prepositioned, which can make it easier for the user to find and use these screening items, thereby better satisfying the use demands on screening of the user.

In a possible implementation, prior to mixing and sorting the plurality of recommended search terms and vertical category tags, the recommended terms may be subjected to a deduplication process.

Specifically, a semantic match is performed on the plurality of recommended search terms and the vertical category tags and it is determined whether there is a recommended search term which is semantically matched with the vertical category tag among the plurality of recommended search terms; and if yes, the recommended search term which is semantically matched with the vertical category tag is deleted.

Considering that the plurality of recommended search terms are matched with the search information, that is, the plurality of recommended search terms are determined in accordance with the search information, there may be a recommended search term which is semantically similar to the vertical category tag among the plurality of recommended search terms, for example, the recommended search term “photos” is a recommended search term with similar semantics as the vertical category tag “pictures”, or the recommended search term “recent photos” is a recommended search term with similar semantics as the vertical category tag “pictures”. Therefore, prior to mixing and sorting the plurality of recommended search terms and the vertical category tags, a semantic match can be performed on the plurality of recommended search terms and the vertical category tags to determine whether there is a recommended search term which is semantically matched with the vertical category tag among the plurality of recommended search terms; if yes, the recommended search terms which is semantically matched with the vertical category tag is deleted; specifically, a semantic match algorithm may be used to calculate text similarities between the plurality of recommended search terms and the vertical category tags, and in the case where a text similarity is greater than a similarity threshold, it may be determined that there is a recommended search term which is semantically matched with the vertical category tag among the plurality of recommended search terms, then the recommended search term which is semantically matched with the vertical category tag may be deleted.

Here, since there may be a recommended search term which is semantically similar to the vertical category tag among the plurality of recommended search terms, and meanwhile, the vertical category tag is more standardized than the recommended search term; thus, prior to mixing and sorting the plurality of recommended search terms and the vertical category tags, the semantic match can be performed on the plurality of recommended search terms and the vertical category tags to determine whether there is a recommended search term which is semantically matched with the vertical category tag among the plurality of recommended search terms; if yes, the recommended search term which is semantically matched with the vertical category tag is deleted; as a result, the presented screening items are more standardized with no redundancy, thereby reducing any interference that may be caused to the user and improving the user experience.

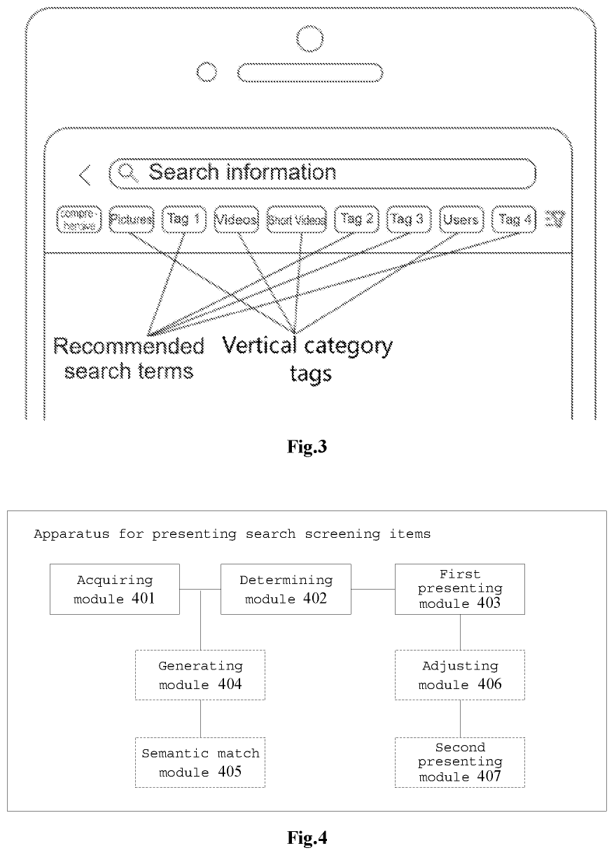

In the above S203, subsequent to determining a sequence of screening items obtained after the mixing and sorting, the sequence of screening items obtained after the mixing and sorting may be presented in a navigation bar of a search page. Referring to FIG. 3, the sequence of screening items obtained after the mixing and sorting includes pictures, Tag 1, videos, short videos, Tag 2, Tag 3, users, and Tag 4; wherein pictures, videos, short videos, and users are vertical category tags, while Tag 1, Tag 2, Tag 3, and Tag 4 are recommended search terms. The search page here may be a page before initiating a search based on the search information, and at this time, a particular screening item may be selected first and then a search may be initiated, so that the search result page directly presents the search results matched with the screening item. The search page may also be a search result page after initiating a search based on the search information, so that after the search results are obtained, the screening item may be then selected to further screen and present the search results in the search result page.

In a possible implementation, subsequent to presenting the sequence of screening items obtained after the mixing and sorting, the method further comprises: adjusting the order of respective screening items in the sequence of screening items in accordance with trigger operation data for the respective screening items in the sequence of screening items.

In an implementation, subsequent to presenting the sequence of screening items obtained after the mixing and sorting, the order of the respective screening items in the sequence of screening items can be adjusted in accordance with trigger operation data for the respective screening items in the sequence of screening items; that is, the consumption data of the multimedia content corresponding to the respective screening items may be counted in real time to obtain new consumption data of the multimedia content corresponding to the respective screening items, further, in accordance with the new consumption data of the multimedia content corresponding to the respective screening items, the order of the respective screening items in the sequence of screening items is adjusted and a presentation is performed in accordance with the adjusted order of the respective screening items.

Here, in the searching process of the user, the sorting of the respective screening items can be dynamically adjusted based on the use condition of the user for the respective presented screening items, so that the sorting of the screening items better meet the current demand of the user.

In a possible implementation, subsequent to presenting the sequence of screening items obtained after the mixing and sorting, the method further comprises: in response to a trigger operation for a target vertical category tag in the sequence of screening items, setting the target vertical category tag to be in a selected state, and presenting respective search results under the target vertical category tag for the search information; and/or, in response to a trigger operation for a recommended search term in the sequence of screening items, setting a comprehensive tag in the search page to be in a selected state, and presenting respective search results matched with the search information and the recommended search term.

In an implementation, subsequent to presenting a sequence of screening items obtained after the mixing and sorting, it is also possible that, in response to a trigger operation for a target vertical category tag in the sequence of screening items, the target vertical category tag may be set to be in a selected state, such as, the target vertical category tag may be set to be highlighted; and respective search results matched with the target vertical category tag may be presented; exemplarily, when the search information is “electric bicycle”, after the user clicks the vertical category tag “pictures” in the sequence of screening items, in response to the trigger operation on the target vertical category tag “pictures” in the sequence of screening items, the target vertical category tag “pictures” is set to be highlighted, and picture information related to the electric bicycle may be presented below the navigation bar of the search page.

Furthermore, it is also possible that, in response to a trigger operation for a recommended search term in the sequence of screening items, a comprehensive tag in the search page may be set to be in a selected state, and respective search results matched with the recommended search term may be presented; exemplarily, when the search information is “Peking University”, after the user clicks the recommended search term “introduction to university history” in the sequence of screening items, in response to the trigger operation on the recommended search term “introduction to university history” in the sequence of screening items, the comprehensive tag in the search page may be set to be highlighted, and information related to the introduction to university history of Peking University may be presented below the navigation bar of the search page.

Here, with respect to the vertical category tags and the search recommended terms, the embodiments of the present disclosure support that they use different result linking modes, wherein after the vertical category tag is triggered, the search results are the multimedia content under this vertical category tag corresponding to the original search information, while after the search recommended term is triggered, the original search information and this search recommended term form the merged search information, and the presented search results are the multimedia content matched with the merged search information.

It can be understood by those skilled in the art that in the above method of the specific embodiment, the order in which the steps are drafted does not imply a strict order of execution and does not impose any limitation on the implementing procedure, rather the specific order of execution of the steps should be determined by functions and possible inherent logics thereof.

### Embodiment Two

Based on the same concept, the embodiments of the present disclosure further provide an apparatus for presenting search screening items, with reference to FIG. 4, which is a schematic structural diagram of an apparatus for presenting search screening items provided by an embodiment of the present disclosure, it comprises an acquiring module 401, a determining module 402, and a first presenting module 403, specifically as follows:
an acquiring module 401 configured to, in response to receiving search information, acquire a plurality of recommended search terms matched with the search information;
a determining module 402 configured to determine a sequence of screening items obtained after mixing and sorting the plurality of recommended search terms and vertical category tags; and
a first presenting module 403 configured to present the sequence of screening items obtained after the mixing and sorting in a navigation bar of a search page.

In a possible implementation, the determination module 402, when determining a sequence of screening items obtained after mixing and sorting the plurality of recommended search terms and vertical category tags, is configured to:
determine an association relation between each of the recommended search terms and each of the vertical category tags, based on consumption data of multimedia content corresponding to each of the recommended search terms under each of the vertical category tags; and
determine the sequence of screening items obtained after mixing and sorting the plurality of recommended search terms and vertical category tags in accordance with the determined association relation.

In a possible implementation, the apparatus further comprises a generating module 404; wherein the generating module 404 is configured to generate the sequence of screening items in accordance with the following steps:
determining a priority order of the vertical category tags based on the search information;
determining a plurality of prepositive vertical category tags from the vertical category tags in accordance with the priority order; and
taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

In a possible implementation, the generating module 404, when determining a priority order of the vertical category tags based on the search information, is configured to:
determine the priority order of the vertical category tags based on consumption data of multimedia content under a search category to which the search information belongs.

In a possible implementation, the generating module 404, when determining a plurality of prepositive vertical category tags from the vertical category tags in accordance with the priority order, is configured to:
select a first number of first vertical category tags which are top-ranked, in an order from high to low of the priority order; and
perform a union process on the first number of first vertical category tags and a plurality of preset second vertical category tags, and take the vertical category tags in the resulted union as the plurality of prepositive vertical category tags.

In a possible implementation, the generating module 404, when taking what is resulted after mixing and sorting the plurality of prepositive vertical category tags and the plurality of recommended search terms as prepositive screening items of the sequence of screening items, is configured to:
in the case where the number of the recommended search terms is greater than a second number, select the second number of recommended search terms from the plurality of recommended search terms, in accordance with degree of correlation between the plurality of recommended search terms and the search information and/or consumption data of multimedia content corresponding to the plurality of recommended search terms;
take what is resulted after mixing and sorting the plurality of prepositive vertical category tags and the second number of recommended search terms as the prepositive screening items of the sequence of screening items;
the generating module 404, when taking vertical category tags other than the prepositive vertical category tags among the vertical category tags as postpositive screening items of the sequence of screening items, is configured to:
take the vertical category tags other than the prepositive vertical category tags, as well as the recommended search terms other than the second number of recommended search terms among the plurality of recommended search terms, as the postpositive screening items of the sequence of screening items.

In a possible implementation, the apparatus further comprises a semantic match module 405; wherein the semantic match module 405, prior to mixing and sorting the plurality of recommended search terms and vertical category tags, is further configured to:
perform a semantic match on the plurality of recommended search terms and the vertical category tags, and determine whether there is a recommended search term which is semantically matched with the vertical category tag among the plurality of recommended search terms; and
if yes, delete the recommended search term which is semantically matched with the vertical category tag.

In a possible implementation, the apparatus further comprises an adjusting module 406; wherein the adjusting module 406, subsequent to presenting the sequence of screening items obtained after the mixing and sorting, is further configured to:
adjust the order of respective screening items in the sequence of screening items in accordance with trigger operation data for the respective screening items in the sequence of screening items.

In a possible implementation, the apparatus further comprises a second presenting module 407; wherein the second presenting module 407, subsequent to presenting the sequence of screening items obtained after the mixing and sorting, is further configured to:
in response to a trigger operation for a target vertical category tag in the sequence of screening items, set the target vertical category tag to be in a selected state, and present respective search results under the target vertical category tag for the search information; and/or
in response to a trigger operation for a recommended search term in the sequence of screening items, set a comprehensive tag in the search page to be in a selected state, and present respective search results matched with the search information and the recommended search term.

In some embodiments, the functions or the included templates of the apparatus provided in the embodiment of the present disclosure may be used to execute the method as described in the above method embodiment, and for a specific implementation, reference may be made to the description of the above method embodiment, and for the sake of brevity, details are not described here again.

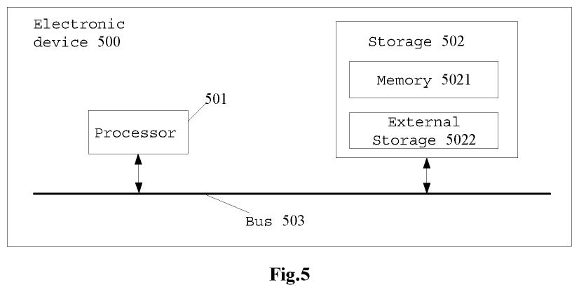

Based on the same technical concept, the embodiments of the present disclosure further provide an electronic device. Referring to FIG. 5, which is a schematic structural diagram of an electronic device provided by an embodiment of the present disclosure, the electronic device comprises a processor 501, a storage 502, and a bus 503. Herein, the storage 502 is configured to store execution instructions and includes a memory 5021 and an external storage 5022; the memory 5021 here is also referred to as an internal storage, which is configured to temporarily store computing data in the processor 501 and data exchanged with the external storage 5022 such as a hard disk or the like, and the processor 501 exchanges data with the external storage 5022 via the memory 5021. When the electronic device 500 runs, the processor 501 communicates with the storage 502 via the bus 503, so that the processor 501 executes the following instructions:
in response to receiving search information, acquiring a plurality of recommended search terms matched with the search information;
determining a sequence of screening items obtained after mixing and sorting the plurality of recommended search terms and vertical category tags; and
presenting the sequence of screening items obtained after the mixing and sorting in a navigation bar of a search page.

Herein, for the specific process flow of the processor 501, reference may be made to the description in the above method embodiment, and details are not described here again.

Further, the embodiments of the present disclosure further provide a computer-readable storage medium, storing thereon a computer program which, when executed by a processor, causes the processor to perform the steps of the method for presenting search screening items in the above method embodiment. Herein, the storage medium may be a volatile or non-volatile computer-readable storage medium.

The embodiments of the present disclosure further provide a computer program product which carries program codes, wherein instructions included in the program codes may be used for performing the steps of the method for presenting search screening items in the above method embodiment. Reference can be made to the above method embodiment, and no further description is made herein.

Herein, the above computer program product may be implemented by hardware, software or a combination thereof. In an optional embodiment, the computer program product is embodied as a computer storage medium, and in another optional embodiment, the computer program product is embodied as a software product, such as a Software Development Kit (SDK) or the like.

It can be clearly understood by those skilled in the art that, in view of convenience and simplicity of description, for the specific working process of the system and the apparatus as described above, references may be made to the corresponding process in the foregoing method embodiment, and no more details are described herein. In the several embodiments provided in the present disclosure, it should be understood that the disclosed system, apparatus and method may be implemented in other ways. The above-described apparatus embodiment is merely illustrative; for example, the division of the units is merely one type of logical function division, and in practical implementation, other division manners may exist; a further example is that multiple units or components may be combined or integrated into another system, or some features may be omitted or not implemented. In addition, the shown or discussed coupling or direct coupling or communication connection between one another may be realized via some communication interfaces, and indirect coupling or communication connection between devices or units may be in an electrical, mechanical or another form.

The units described as separate components may or may not be physically separate, and components displayed as units may or may not be physical units, that is, they may be located in one position, or may be distributed on multiple network units. Some or all of the units can be selected in accordance with actual needs to achieve the purpose of the solution of the present embodiment.

Further, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a Non-volatile computer-readable storage medium which is executable by a processor. Based on such understanding, the essential part or the part contributing to the related art of the technical solutions of the present disclosure, or parts of the technical solutions, may be embodied in the form of a software product, and the computer software product is stored in one storage medium and comprises several instructions for causing one computer device (which may be a personal computer, a server, a network device, or the like) to perform all or part of the steps of the method described in the embodiment of the present disclosure. And the aforementioned storage medium includes various medium that can store program codes, such as U disk, mobile hard disk drive, Read-Only Memory (ROM), Random Access Memory (RAM), magnetic disk or optical disk, and the like.

The embodiments as described above are merely specific implementations of the present disclosure, and the scope of protection of the present disclosure is not limited thereto; any variation or replacement which can be easily conceived of by any of those skilled in the art shall all be included in the scope of protection of the present disclosure. Thus, the scope of protection of the present disclosure shall be determined by the terms of the claims.

What is claimed is:

1. A method for presenting search screening items, comprising:
in response to receiving search information, acquiring a plurality of recommended search terms matched with the search information;
determining a sequence of screening items obtained after mixing and sorting the plurality of recommended search terms and vertical category tags; and
presenting the sequence of screening items obtained after the mixing and sorting in a navigation bar of a search page.

2. The method according to claim 1, wherein the determining a sequence of screening items obtained after mixing and sorting the plurality of recommended search terms and vertical category tags comprises:
determining an association relation between each of the recommended search terms and each of the vertical category tags, based on consumption data of multimedia content corresponding to each of the recommended search terms under each of the vertical category tags; and
determining the sequence of screening items obtained after mixing and sorting the plurality of recommended search terms and vertical category tags in accordance with the determined association relation.

3. The method according to claim 1, wherein the sequence of screening items is generated in accordance with the following steps of:
determining a priority order of the vertical category tags based on the search information;
determining a plurality of prepositive vertical category tags from the vertical category tags in accordance with the priority order; and
taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

4. The method according to claim 3, wherein the determining a priority order of the vertical category tags based on the search information comprises:
determining the priority order of the vertical category tags based on consumption data of multimedia content under a search category to which the search information belongs.

5. The method according to claim 3, wherein the determining a plurality of prepositive vertical category tags from the vertical category tags in accordance with the priority order comprises:
selecting a first number of first vertical category tags which are top-ranked, in an order from high to low of the priority order; and
performing a union process on the first number of first vertical category tags and a plurality of preset second vertical category tags, and taking the vertical category tags in the resulted union as the plurality of prepositive vertical category tags.

6. The method according to claim 3, wherein the taking what is resulted after mixing and sorting the plurality of prepositive vertical category tags and the plurality of recommended search terms as prepositive screening items of the sequence of screening items comprises:
in the case where the number of the recommended search terms is greater than a second number, selecting the second number of recommended search terms from the plurality of recommended search terms, in accordance with degree of correlation between the plurality of recommended search terms and the search information and/or consumption data of multimedia content corresponding to the plurality of recommended search terms; and
taking what is resulted after mixing and sorting the plurality of prepositive vertical category tags and the second number of recommended search terms as the prepositive screening items of the sequence of screening items; and
the taking vertical category tags other than the prepositive vertical category tags among the vertical category tags as postpositive screening items of the sequence of screening items comprises:
taking the vertical category tags other than the prepositive vertical category tags, as well as the recommended search terms other than the second number of recommended search terms among the plurality of recommended search terms, as the postpositive screening items of the sequence of screening items.

7. The method according to claim 1, wherein prior to mixing and sorting the plurality of recommended search terms and vertical category tags, the method further comprises:
performing a semantic match on the plurality of recommended search terms and the vertical category tags, and determining whether there is a recommended search term which is semantically matched with the vertical category tag among the plurality of recommended search terms; and
if yes, deleting the recommended search term which is semantically matched with the vertical category tag.

8. The method in accordance with claim 1, wherein subsequent to presenting the sequence of screening items obtained after the mixing and sorting, the method further comprises:
adjusting the order of respective screening items in the sequence of screening items in accordance with trigger operation data for the respective screening items in the sequence of screening items.

9. The method according to claim 1, wherein subsequent to presenting the sequence of screening items obtained after the mixing and sorting, the method further comprises:
in response to a trigger operation for a target vertical category tag in the sequence of screening items, setting the target vertical category tag to be in a selected state, and presenting respective search results under the target vertical category tag for the search information; and/or
in response to a trigger operation for a recommended search term in the sequence of screening items, setting a comprehensive tag in the search page to be in a selected state, and presenting respective search results matched with the search information and the recommended search term.

10. An electronic device, comprising: a processor, a memory, and a bus, wherein the memory stores machine-readable instructions executable by the processor, the processor and the memory communicate via the bus when the electronic device runs, and the machine-readable instructions, when executed by the processor, cause the processor to perform the following operations for presenting search screening items:
in response to receiving search information, acquiring a plurality of recommended search terms matched with the search information;
determining a sequence of screening items obtained after mixing and sorting the plurality of recommended search terms and vertical category tags; and
presenting the sequence of screening items obtained after the mixing and sorting in a navigation bar of a search page.

11. The electronic device according to claim 10, wherein the determining a sequence of screening items obtained after mixing and sorting the plurality of recommended search terms and vertical category tags comprises:
determining an association relation between each of the recommended search terms and each of the vertical category tags, based on consumption data of multimedia content corresponding to each of the recommended search terms under each of the vertical category tags; and
determining the sequence of screening items obtained after mixing and sorting the plurality of recommended search terms and vertical category tags in accordance with the determined association relation.

12. The electronic device according to claim 10, wherein the sequence of screening items is generated in accordance with the following operations of:
determining a priority order of the vertical category tags based on the search information;
determining a plurality of prepositive vertical category tags from the vertical category tags in accordance with the priority order; and
taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

13. The electronic device according to claim 12, wherein the determining a priority order of the vertical category tags based on the search information comprises:
determining the priority order of the vertical category tags based on consumption data of multimedia content under a search category to which the search information belongs.

14. The electronic device according to claim 12, wherein the determining a plurality of prepositive vertical category tags from the vertical category tags in accordance with the priority order comprises:
selecting a first number of first vertical category tags which are top-ranked, in an order from high to low of the priority order; and
performing a union process on the first number of first vertical category tags and a plurality of preset second vertical category tags, and taking the vertical category tags in the resulted union as the plurality of prepositive vertical category tags.

15. The electronic device according to claim 12, wherein the taking what is resulted after mixing and sorting the plurality of prepositive vertical category tags and the plurality of recommended search terms as prepositive screening items of the sequence of screening items comprises:
in the case where the number of the recommended search terms is greater than a second number, selecting the second number of recommended search terms from the plurality of recommended search terms, in accordance with degree of correlation between the plurality of recommended search terms and the search information and/or consumption data of multimedia content corresponding to the plurality of recommended search terms; and
taking what is resulted after mixing and sorting the plurality of prepositive vertical category tags and the second number of recommended search terms as the prepositive screening items of the sequence of screening items; and
the taking vertical category tags other than the prepositive vertical category tags among the vertical category tags as postpositive screening items of the sequence of screening items comprises:
taking the vertical category tags other than the prepositive vertical category tags, as well as the recommended search terms other than the second number of recommended search terms among the plurality of recommended search terms, as the postpositive screening items of the sequence of screening items.

16. A non-transitory computer-readable storage medium, storing thereon a computer program which, when executed by a processor, causes the processor to perform the following operations for presenting search screening items:
in response to receiving search information, acquiring a plurality of recommended search terms matched with the search information;
determining a sequence of screening items obtained after mixing and sorting the plurality of recommended search terms and vertical category tags; and
presenting the sequence of screening items obtained after the mixing and sorting in a navigation bar of a search page.

17. The computer-readable storage medium according to claim 16, wherein the determining a sequence of screening items obtained after mixing and sorting the plurality of recommended search terms and vertical category tags comprises:
determining an association relation between each of the recommended search terms and each of the vertical category tags, based on consumption data of multimedia content corresponding to each of the recommended search terms under each of the vertical category tags; and
determining the sequence of screening items obtained after mixing and sorting the plurality of recommended search terms and vertical category tags in accordance with the determined association relation.

18. The computer-readable storage medium according to claim 16, wherein the sequence of screening items is generated in accordance with the following operations of:
determining a priority order of the vertical category tags based on the search information;
determining a plurality of prepositive vertical category tags from the vertical category tags in accordance with the priority order; and
taking what is resulted after mixing and sorting the plurality of prepositive vertical category tags and the plurality of recommended search terms as prepositive screening items of the sequence of screening items, and taking the vertical category tags other than the prepositive vertical category tags among the vertical category tags as postpositive screening items of the sequence of screening items; wherein the prepositive screening items are used for being arranged before the postpositive screening items.

19. The computer-readable storage medium according to claim 18, wherein the determining a priority order of the vertical category tags based on the search information comprises:
determining the priority order of the vertical category tags based on consumption data of multimedia content under a search category to which the search information belongs.

20. The computer-readable storage medium according to claim 18, wherein the determining a plurality of prepositive vertical category tags from the vertical category tags in accordance with the priority order comprises:
selecting a first number of first vertical category tags which are top-ranked, in an order from high to low of the priority order; and
performing a union process on the first number of first vertical category tags and a plurality of preset second vertical category tags, and taking the vertical category tags in the resulted union as the plurality of prepositive vertical category tags.
